(19) United States
(12) Patent Application Publication
(10) Pub. No.: US 2025/0322147 A1
(43) Pub. Date: Oct. 16, 2025

(54) SYSTEM FOR PROVIDING AUTOFILL OF CONSIGNMENT RECALL TEMPLATE AND A METHOD THEREOF

(71) Applicant: HONEYWELL INTERNATIONAL INC., Charlotte, NC (US)

(72) Inventors: Ankit Singh, Apex, NC (US); Lakshminarayana Paila, Knoxville, TN (US)

(21) Appl. No.: 18/631,238

(22) Filed: Apr. 10, 2024

(51) Int. Cl. G06F 40/174; G06F 3/0486; G06F 40/186; G06Q 30/014

(52) U.S. Cl. CPC G06F 40/174; G06F 3/0486; G06F 40/186; G06Q 30/014

(57) ABSTRACT

The present invention disclosure provides a system for auto-filling a consignment recalling template. The system comprising a processor and a memory coupled with each other. According to an embodiment, the processor, of the system, is configured to provide a User Interface (UI) to one or more entities, said UI displaying a template and a plurality of objects for selection by the entity, where the entity distributes products to one or more end users. Further, the processor is configured to identify at least one product to be recalled from the one or more end users and select at least one object from the plurality of objects, the object representing a field associated with the template. Further, the processor is configured to retrieve, based on the selection on the at least one object, one or more data corresponding to the at least one object from a database. Further, the processor is configured to auto-fill the selected fields of the template based on the one or more data retrieved from the database. Further, the processor is configured to generate at least one recalling prompt based on auto-filled template and send the generated recalling prompt to the one or more end.

### FIELD OF INVENTION

The present disclosure generally relates to a product recall management system. More specifically, the present disclosure provides a system and a method for an automatic filling of a consignment recall template.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Generally, products that are available in a market are received from a manufacturer (may be referred to as “entity”) via multiple consignees (may be referred to as “vendors”. In general, the entities produce the products that are further distributed through multiple vendors forming a supply chain with one or more customers (i.e. the end users). The products that are available in the market undergo a rigorous process at a manufacturer's end before dispatching them to the consignees. However, in certain scenarios, the products dispatched to the consignees can be found faulty after dispatching. In a non-limiting example, the dispatched products can be found to be faulty due to various reasons such as regulatory noncompliance, quality noncompliance, dispensing and packaging issues, product expiration, supply chain problems, etc. Therefore, in order to maintain consumer safety and regulatory compliance, such faulty products are required to be recalled from the consignees.

Conventionally, the entities issue letters/notifications to vendors, internal manufacturing units, or the end users for recalling such products. According to conventional art, the letters/notifications are issued manually in accordance with a specific template. The template, generally, has predefined fields that are required to be filled with information respective to each of the vendors, internal manufacturing units, or the end users. As an example, the information may include the name of the vendor or the end users, company name, company address, product details, and the like. Thus, manually filling in such information and sending the letters/notifications to each of the vendors, internal manufacturing units, or the end users which are large in number can be inefficient, time-consuming, and prone to errors.

Thus, there is a need to provide a system and a method to mitigate the above-mentioned issues related to the generation and filling of the template.

Through applied effort, ingenuity, and innovation, the inventors have solved the above problem(s) by developing the solutions embodied in the present disclosure, the details of which are described further herein.

### SUMMARY OF THE INVENTION

In general, embodiments of the present disclosure herein provide a solution in which a template is created and auto-fill functionality is provided for automatically populating the data that is to be filled in respective fields of the template. Other implementations will be or will become, apparent to one with skill in the art upon examination of the following figures and detailed description. It is intended that all such additional implementations be included within this description be within the scope of the disclosure and be protected within the scope of the following claims.

In one embodiment, the present disclosure discloses a system for auto-filling a consignment recalling template. The system includes a processor and a memory storing program instructions. The program instruction stored in the memory when executed by the processor, causes the processor to provide a User Interface (UI), to one or more entities, displaying a template and one or more objects for selection by the entity. The entity distributes products to one or more end users. Further, the processor is further configured to identify at least one product to be recalled from the one or more end users. Furthermore, the processor is further configured to select at least one object from the plurality of objects, the object representing a field associated with the template. Based on the selection on the at least one object, the processor is further configured to retrieve one or more data corresponding to the at least one object from a database. Further, the processor is configured to auto-fill the selected fields of the template based on the one or more data retrieved from the database. Further, the processor is further configured to generate at least one recalling prompt based on the auto-filled template. Further, the processor is further configured to send the generated recalling prompt to the one or more end users.

In another embodiment, the present disclosure provides a method for auto-filling the consignment recalling template. The method includes providing a User Interface (UI), to one or more entities, displaying a template and one or more objects for selection by the entity. The entity distributes products to one or more end users. The method further includes identifying at least one product to be recalled from the one or more end users. Further, the method includes selecting at least one object from the plurality of objects, the object representing a field associated with the template. Further, the method includes retrieving, based on the selection on the at least one object, one or more data corresponding to the at least one object from a database. Further, the method includes auto-filling the selected fields of the template based on the one or more data retrieved from the database. Thereafter, the method includes generating at least one recalling prompt based on the auto-filled template and sending the generated recalling prompt to the one or more end users.

In yet another embodiment, the present disclosure provides a non transitory computer-readable storage medium storing program instructions for auto-filling the consignment recalling template. The program instructions, when executed, perform the steps of providing a User Interface (UI), to one or more entities, displaying a template and one or more objects for selection by the entity. The entity distributes products to one or more end users. The program instructions, when executed, further perform the steps of identifying at least one product to be recalled from the one or more end users. Further, the program instructions, when executed, perform the steps of selecting at least one object from the plurality of objects, the object representing a field associated with the template. Further, based on the selection on the at least one object, the program instructions, when executed, perform the steps of retrieving one or more data corresponding to the at least one object from a database. The program instructions, when executed, further perform the steps of auto-filling the selected fields of the template based on the one or more data retrieved from the database. Further, the program instructions, when executed, perform the steps of generating at least one recalling prompt based on the auto-filled template and sending the generated recalling prompt to the one or more end users.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an example working environment of the system for auto-filling a consignment recalling template, in accordance with an embodiment of the present disclosure;

FIG. 2 illustrates an example block diagram of the system depicted in FIG. 1, in accordance with an embodiment of the present disclosure;

FIG. 3 illustrates another example block diagram of the system depicted in FIG. 2, in accordance with an embodiment of the present disclosure;

FIG. 4 illustrates various predefined consignment templates displayed on the UI, in accordance with an embodiment of the present disclosure;

FIG. 5 illustrates one or more objects displayed on the UI for selection, according to an embodiment of the present disclosure;

FIG. 6 illustrates an example of a blank consignment recalling template, in accordance with an embodiment of the present disclosure;

FIG. 7 illustrates a flow chart of a method for auto-filing the blank consignment recalling template, according to an embodiment of the present disclosure;

FIG. 8 illustrates an example of an auto-filled consignment recalling template, according to an embodiment of the present disclosure;

FIG. 9 illustrates a method for auto-filling a consignment recalling template, in accordance with an embodiment of the present disclosure; and

FIG. 10 illustrates a general block diagram of the system, according to an embodiment of the present disclosure.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations

The present disclosure relates to a system and a method for auto-filling a consignment recalling template. According to an embodiment, the system creates the consignment recalling template based on a selection of one or more objects. The corresponding objects represent the corresponding field in the consignment recalling template. In an embodiment, the system is provided with the auto-fill functionality for automatically populating the data to be filled in respective fields of the consignment recalling template. The system retrieves associated data from a database of the entity by using semantic similarity or vector similarity between the fields and the information stored in the database of the entity. In an embodiment, the system generates and sends recalling prompts based on the auto-filled template. The disclosed technique accelerates the creation and distribution of the auto-filled template for recalling faulty products. A detailed explanation of the system and the method for auto-filling the consignment recalling template will be provided in the forthcoming paragraphs.

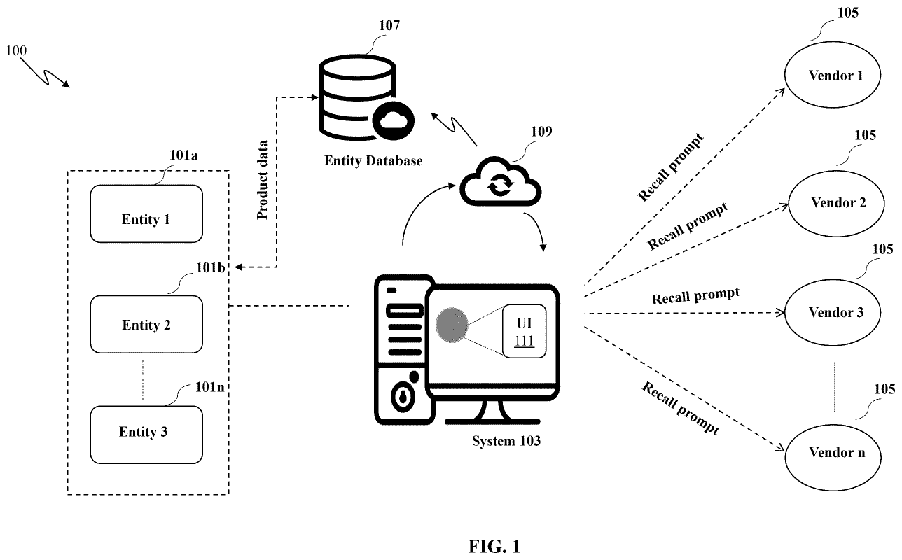

FIG. 1 illustrates an example working environment of the system for auto-filling a consignment recalling template, in accordance with an embodiment of the present disclosure. FIG. 1 depicts an environment 100 that includes one or more entities (e.g. entity 1 101a, entity 2 101b, entity 3 101n), a system 103, and one or more vendors 105 (e.g. vendor 1, vendor 2, vendor 3, and vendor n) operatively coupled with each other. The ‘one or more entities’ and ‘one or more vendors’ may be collectively labeled as ‘101’ and ‘105’ respectively. Further, the ‘one or more entities’ and ‘one or more vendors’ may be alternately referred to as ‘entities’ and ‘vendors’.

In a non-limiting example, the entities 101 may include manufacturers, companies, or organizations that manufacture consumer products like pharmaceutical products, personal care products, health & wellness products, medical devices, and the like. The examples and explanations provided throughout the disclosure are related to life sciences consumer products and should not be construed as limiting, as the disclosed system 103 and the method implemented therein can be used by any entities belonging to any realm. Further, in a non-limiting example, the vendors 105 may include suppliers, merchants, distributors, resellers, sellers, traders, consignees, and the like. According to a further non-limiting example, the system 103 may be a computer, a laptop, a smartphone, or any electronic machine.

According to an embodiment, each of the entities 101 may have an entity database 107. According to an example, the entity database 107 is the entities 101 proprietary database that can be controlled by an authorized person associated with the entities. The authorized person may be alternately referred to as the entity throughout the disclosure as the authorized person is associated with the entity. Further, the entity database 107 may be implemented in the system 103 or virtually implemented in a cloud server. According to the example environment 100 as depicted in FIG. 1, the entity database 107 is virtually implemented in the cloud server. According to an embodiment, the entity database 107 includes information related to the consumer product that was manufactured by the entities 101. In a non-limiting example, the information may include a name of the product, a type of the product, a category of the product, a date of manufacturing of the product, a date of dispatch of the product, the vendor's name, vendor's address, an authorized name associated with the vendor, vendor's contact details, a lot number of the dispatched product, the lot number of the manufactured product, a lot size of the dispatched product, the lot size of the manufactured product, remarks on the process of manufacturing of the product remarks on the dispatched product, and the like. In an embodiment, the information can be stored in the entity database 107 according to a specific format, a specific structure, or data models as defined at the entities 101 ends.

According to a further embodiment, the system 103 is operatively coupled with a data management cloud service 109 for fetching the information related to the consumer product during auto-filing of the consignment recalling template. The system 103 further includes a database that includes various consignment recalling templates. In an embodiment, the system 103 is implemented with a recall execution application (App) 110. In an example scenario, consider that one of the entities 101 has found that the faulty product has been dispatched to various vendors 105. In such a scenario, the entity 101 uses the recall execution App 110 to initiate the consignment recall process. According to an embodiment, the entity 101 can initiate the consignment recall process by operating the recall execution App 101. Further, the system provides a user interface (UI) 111 that is configured to display various predefined consignment templates for recalling the dispatched product. In an embodiment, the UI 111 enables the entity 101 to select one or more objects. The objects determine one or more fields to be selected as part of consignment recalling templates for recalling the dispatched product. In a non-limiting example, the one or more fields represent a name, a firm name, a firm address, a lot number, a lot size, a product name, etc. In an embodiment, once the entity selects one or more objects, the system 103 auto-fills corresponding fields in the consignment recalling template based on the selected objects. In particular, the system 103 retrieves appropriate information associated with the selected objects from the entity database 107 via the data management cloud service 109 and dynamically auto-fills the corresponding fields in the consignment recalling template with correct information. In an embodiment, the system 103 is implemented with semantic similarity or vector similarity techniques to identify the correct information from the entity database 107. Accordingly, the system 103 generates one or more auto-filled consignment recalling templates.

According to an embodiment, the system 103 generates one or more prompts and sends the generated one or more recalling prompts to the vendors 105 for distributing the auto-filled consignment recalling templates to the vendors 105. In a non-limiting example, the one or more recalling prompts can be an e-mail, a fax, a short message service (SMS), a notification, a broadcast message, and the like. The forthcoming paragraphs will explain various components of the system 103 in detail. The labels depicted in the representative drawings are kept same for similar components throughout the disclosure for ease of understanding.

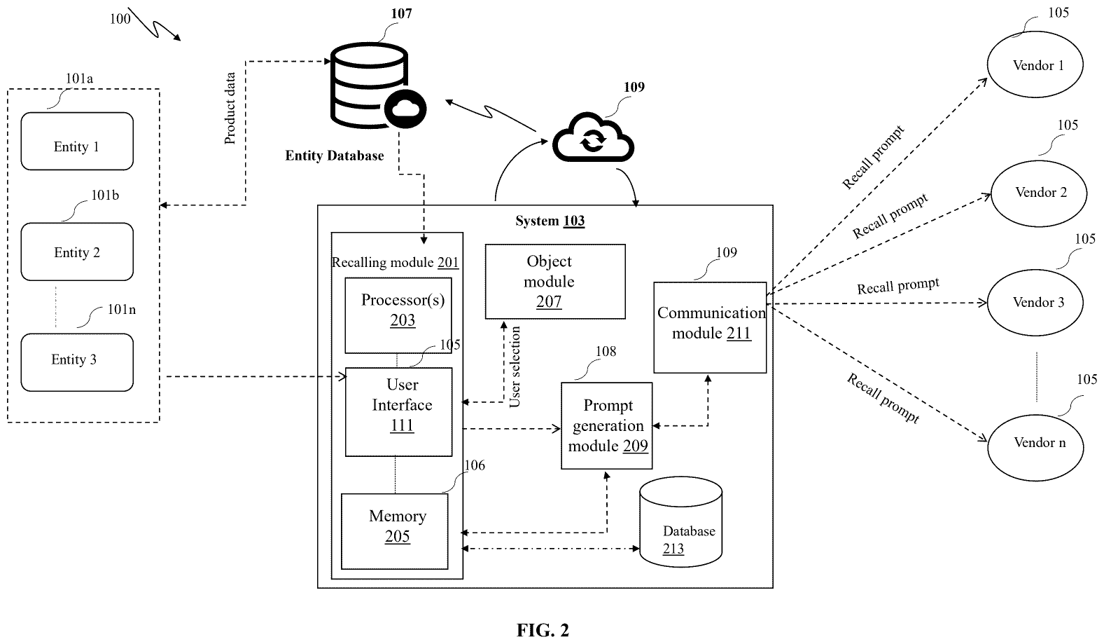

FIG. 2 illustrates an example block diagram of the system depicted in FIG. 1, in accordance with an embodiment of the present disclosure. According to an embodiment, the system 103 includes a recalling module 201, an object module 207, a prompt generation module 209, a communication module 211, and a database 213. According to an embodiment, the recalling module 201, the object module 207, the prompt generation module 209, the communication module 211, and the database 213 are operatively coupled with each other. In an embodiment, the recalling module 201 further includes a processor(s) 203, the user interface (UI) 111, and a memory 205 coupled with each other. According to an embodiment, the recalling module 201 is coupled with the vendors 105.

In an embodiment, the memory 205 is configured to store program instructions which, when executed by the processor(s) 203, causes the processor(s) 203 to perform a series of operations. According to some embodiments, functions of the object module 207, the prompt generation module 209, and the communication module 211 can be performed by the processor(s) 203. According to one or more embodiments, the recalling module 201, the object module 207, the prompt generation module 209, the communication module 211 are uniquely designed hardware modules or software modules.

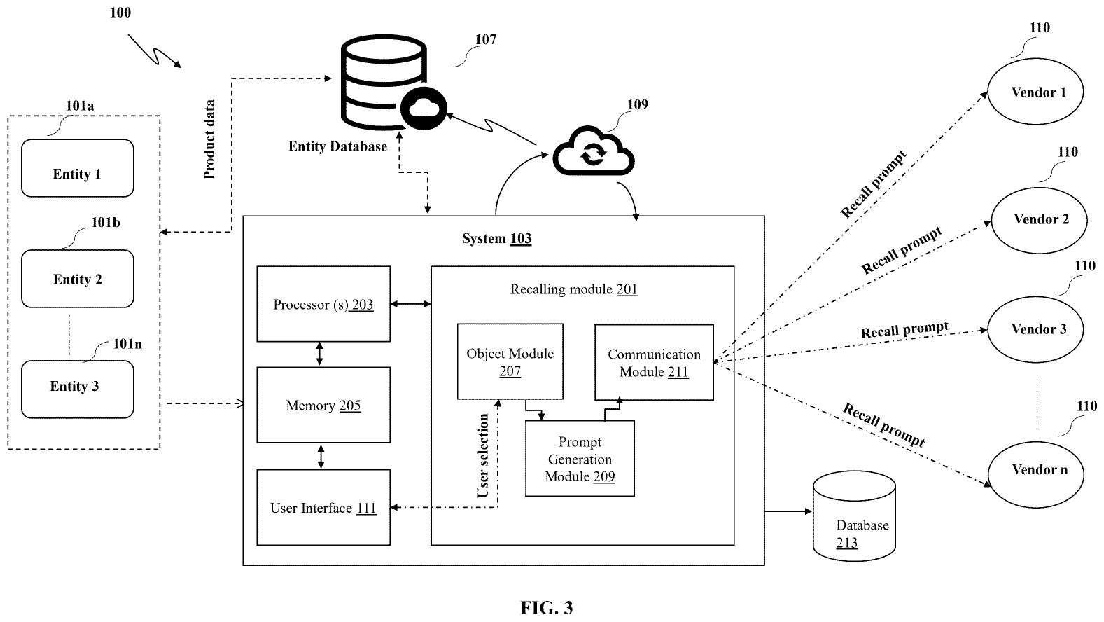

FIG. 3 illustrates another example block diagram of the system depicted in FIG. 2, in accordance with an embodiment of the present disclosure. According to the example embodiment as depicted in FIG. 3, the recalling module 201 includes the object module 207, the prompt generation module 209, and the communication module 211. The recalling module 201 is further coupled with processor(s) 203, the memory 205, and the UI 111. In an embodiment, the memory 205 is configured to store program instructions which, when executed by the processor(s) 203, causes the processor(s) 203 to perform a series of operations related to the recalling module 201, the object module 207, the prompt generation module 209, and the communication module 211. In an embodiment, the database 213 may be deployed at a remote server or a cloud. A brief explanation of each of the modules as depicted in FIGS. 2 and 3 will be explained in the forthcoming paragraphs.

According to an embodiment, the UI 111 displays various predefined consignment templates and a list of objects for selection by the entity 101. In a non-limiting example, the UI 111 is a graphical user interface (GUI) where the predefined consignment templates and the list of objects are displayed to the entity 101 for selection by the entity 101. In an embodiment, the UI 111 receives commands from the processor(s) 203. According to some embodiment, the UI 11 is a part of an output device of the system 103. As an example, the output device may be a monitor of the system 103. As an example, the GUIs are typically developed using a combination of software tools and platforms to create visually appealing and user-friendly interfaces.

According to an embodiment, the object module 207 identifies at least one product to be recalled from one or more end users based on the selected consignment template. In an embodiment, the object module 207 is implemented with Artificial intelligence (AI) models to understand a context of the selected consignment template. According to an embodiment, the AI model analyses a text in the selected consignment template, a category of the selected consignment, and recent details of production and dispatch of the product. Based on a result of the analysis the AI model predicts and identifies the product to be recalled. According to a further embodiment, based on the identified product, the object module 207 provides a list of objects to be displayed on the UI 111 for selection by the entity 101. The object module 207 provides the list of objects 503 that are associated with the product. Thus, the list of objects contains relevant objects which helps the entity 101 to select relevant fields from the given list.

According to an embodiment, the recalling module 201 provides an autofill functionality for the consignment recalling templates. In an embodiment, based on the selection of the at least one object the recalling module 201 retrieves one or more data corresponding to the at least one object from the entity database 107. In an embodiment, the recalling module 201 retrieves the one or more data from the entity database 107 based on the semantic similarity or the vector similarity. Based on the one or more data retrieved from the entity database 107, the recalling module 201 auto-fills the selected fields of the consignment recalling template and generates an auto-filled consignment recalling template.

According to a further embodiment, the prompt generation module 209 is configured to generate one or more recalling prompts after the generation of the auto-filled consignment recalling template. In a non-limiting example, the one or more recalling prompts can be an e-mail, a fax, a short message service (SMS), a notification, a broadcast message, and the like. In an embodiment, the UI 111 provides options to select means of distributing the auto-filled consignment recalling template and accordingly, the prompt generation module 209 generates the prompts.

According to a further embodiment, the communication module 211 sends the one or more recalling prompts for distributing the auto-filled consignment recalling template to the one or end users or vendors.

A detailed explanation will be provided by referring to various modules as depicted in FIGS. 2 and 3 in the forthcoming paragraphs.

Referring to FIG. 2 and considering the same example scenario, where the entity 101 initiates the consignment recall process by operating the recall execution App 101. According to an embodiment, as the consignment recall process gets initiated, the recalling module 201 provides the user interface (UI) 111 that is configured to display various predefined consignment templates for recalling the dispatched product.

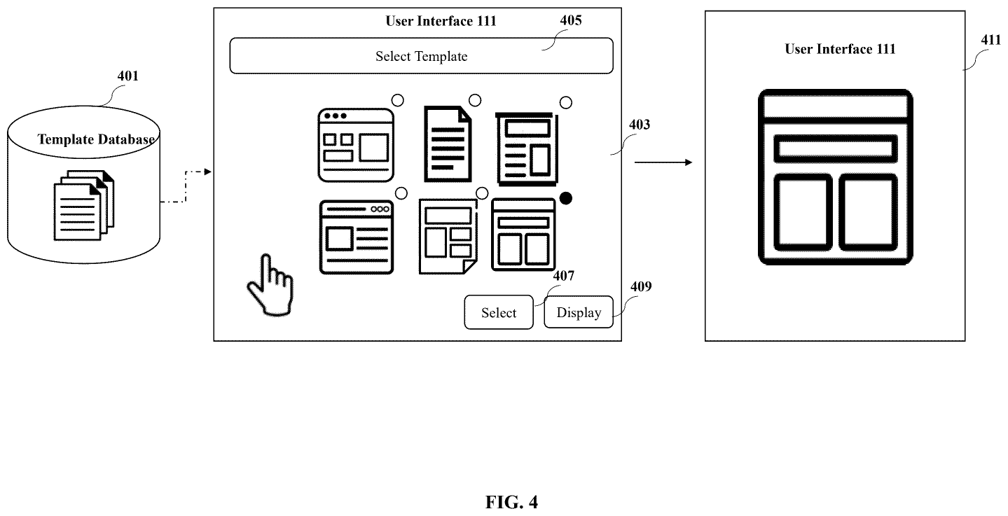

FIG. 4 illustrates various predefined consignment templates displayed on the UI, in accordance with an embodiment of the present disclosure. According to an embodiment, the predefined consignment templates are stored in a template database 401. The template database 107 is included in the database 213. Thus, when the authorized user initiates the consignment recall process, the UI 111 fetches various predefined consignment templates from the template database 401 for displaying on the UI 111 of the output device of the system 103. In a non-limiting example, the UI 111 is the graphical user interface (GUI) where the predefined consignment templates are displayed to the entity 101 for selection. Further, the output device may be a monitor of the system 103.

In an embodiment, the UI 111 displays various predefined consignment templates 403 after fetching various predefined consignment templates from the template database 401. For doing so, UI 111 provides a “select template” 405 tab so that after operating upon the select template 405 tab, the UI 111 displays various predefined consignment templates 403 for selecting any one of the consignment templates. According to a further embodiment, the UI 111 provides a ‘select’ 407 tab and a ‘display’ 409 tab for performing selection and displaying operations. Thus, as the UI 111 displays various predefined consignment templates 403, the entity 101 can select any one of the consignment templates by operating upon the select 407 tab and thereafter can operate upon the display 409 for displaying the selected consignment template. Thus, when the entity 101 selects a particular consignment template, the UI 111 displays the selected consignment template which is depicted in block 411.

According to a further embodiment, the object module 207 is further configured to identify at least one product to be recalled from the one or more end users. In an embodiment, the object module 207 performs identification of the at least one product to be recalled based on the selected consignment template. In an embodiment, the object module 207 uses Artificial intelligence (AI) models to understand the context of the selected consignment template. According to an embodiment, the AI model analyses a text in the selected consignment template, a category of the selected consignment, and recent details of production and dispatch of the product. Based on a result of the analysis the AI model predicts and identifies the product to be recalled.

According to a further embodiment, the user interface (UI) 111 is configured to display one or more objects for the selection by the entity 101. In an embodiment, the selected objects represent a field associated with the template. In particular, the objects determine one or more fields to be selected as part of the consignment recalling template for recalling the dispatched product.

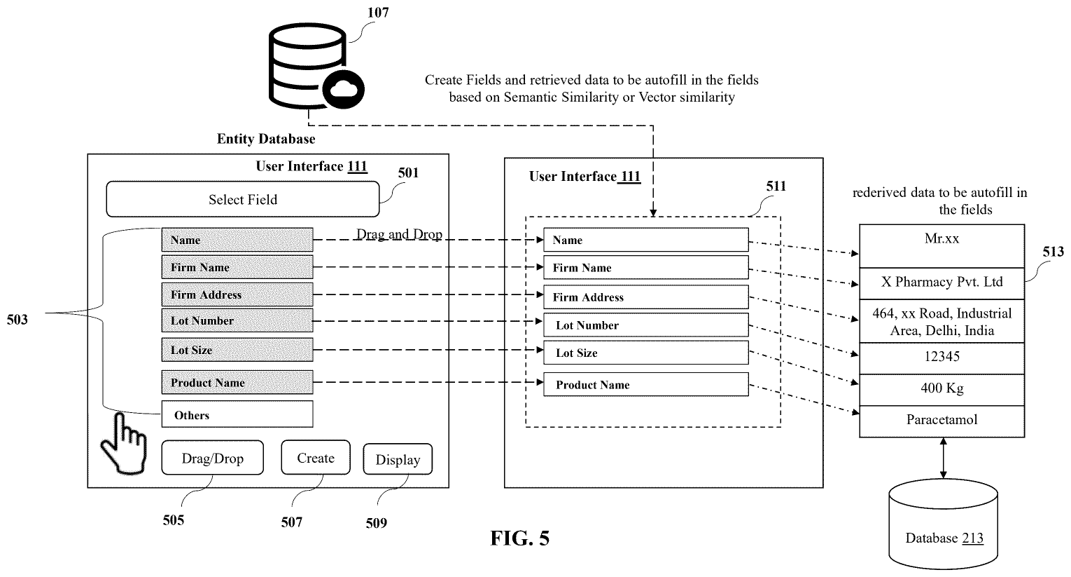

FIG. 5 illustrates one or more objects displayed on the UI for selection, according to an embodiment of the present disclosure. According to an embodiment, the UI 111 provides a ‘select field’ 501 tab for selecting one or more objects that are to be included as a field in the selected consignment recalling template. In an embodiment, based on the identified product, and after operating upon the select field 501, the object module 207 provides a list of objects 503. The list of objects 503 is displayed on the UI 111. In an embodiment, the entity 101 can select one or more objects from the list of objects. The UI 111 provides a ‘select’ 505 tab for selecting one or more objects.

According to the example embodiment, the UI 111 displays the list of objects 503 that includes the name, the firm name, the firm address, the lot number, a lot size, product name, and others. Further, consider that the entity 101 selects the objects including the name, the firm name, the firm address, the lot number, a lot size, product name. In an embodiment, the selected objects are highlighted as depicted in FIG. 5 in order to confirm the selection. According to a further embodiment, the UI 111 provides the entity 101 to perform the drag and drop operation. Accordingly, the entity 101 drags and drops the selected objects at a predetermined location of the UI 111 by operating upon the drag/drop 505 tab. According to an embodiment, the selected objects are placed at the predetermined location of the selected recalling consignment template. In a non-limiting example, a JavaScript framework like Angular or language libraries like React is used for implementing the drag/drop functionality at ease. The UI 111 is designed to support complex drag patterns, reordering of the selected objects, and creating customized objects. The selected objects are displayed on the UI 111 as fields as shown in the block 511.

According to some embodiments, the UI 111 provides an additional ‘create’ tab 507 in a scenario, if the entity 101 wanted to include additional objects in addition to the objects that was displayed in the list of objects 503. According to an embodiment, the entity 101 by operating upon the create 507 tab creates new additional objects, which is further included in the consignment recalling template as new fields. In an embodiment, the newly created objects are further stored in the database 213 for future use. Thus, when the entity 101 initiates the consignment recalling process again, the recalling module 201 includes the newly created objects in the list of objects 503 for selection.

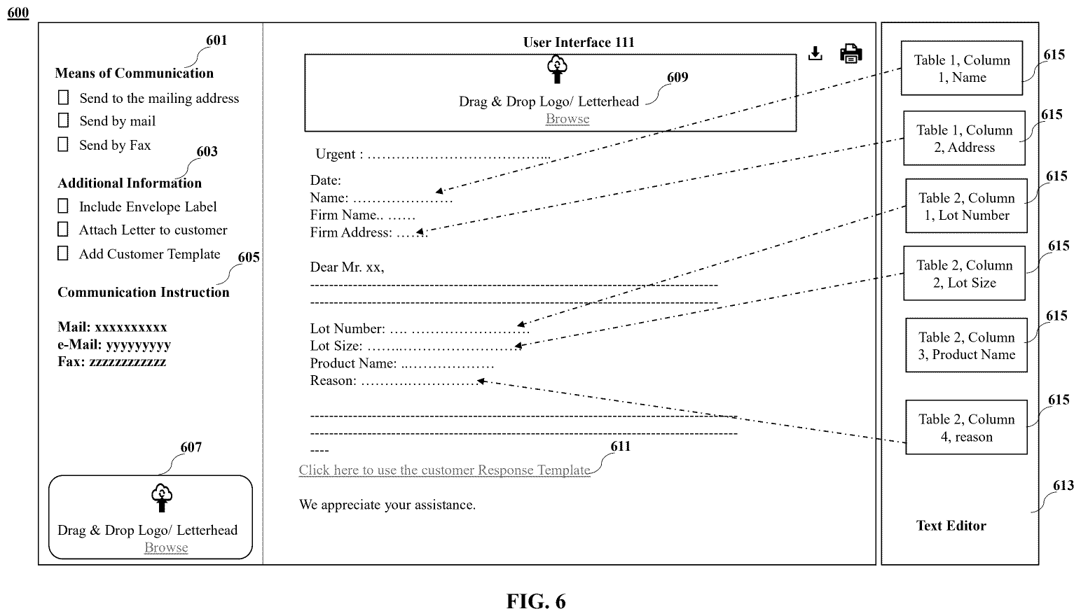

FIG. 6 illustrates an example of a blank consignment recalling template, in accordance with an embodiment of the present disclosure. In an embodiment, after the selection of the consignment recalling template and the one or more objects, as explained in the above paragraphs, the UI 111 generates a blank consignment recalling template 600. According to an embodiment, the generated blank consignment recalling template 600 includes the fields based on the selected objects or newly created objects. Further, the generated blank consignment recalling template 600 includes an area on the left to provide options for selecting at least one of the means of communication 601, additional information 605, and communication instruction 605. Further, at the lower end 607 of the consignment recalling form a drag and drop option or browsing letterhead option for including logo or letterhead is provided. According to a further embodiment, at the upper end 609 of the consignment recalling form the drag and drop option or the browsing letterhead option for including the logo or the letterhead is provided.

In an embodiment, the means of communication 601 includes options to send the auto-filled consignment template. In a non-limiting example, the auto-filled consignment template can be sent via e-mail, fax, SMS, notification, broadcast message, or to any particular mailing address. Further, the additional information 605 includes but is not limited to, options like including an envelop label, attaching a letter to a customer, and adding a customer template. Furthermore, the communication instruction 605 include particular instruction for sharing email, fax and the like. FIG. 6 shows the means of communication 601 for illustrative purposes only and should not be construed as limiting.

According to a further embodiment, after the generation of the blank consignment recalling template 600, the corresponding data in the fields are auto-filled. The present disclosure provides a unique way of auto-filing the blank consignment recalling template 600 by performing appropriate mapping for the information stored in the entity database 107 with fields. The forthcoming paragraphs will explain the techniques of auto-filing the blank consignment recalling template 600.

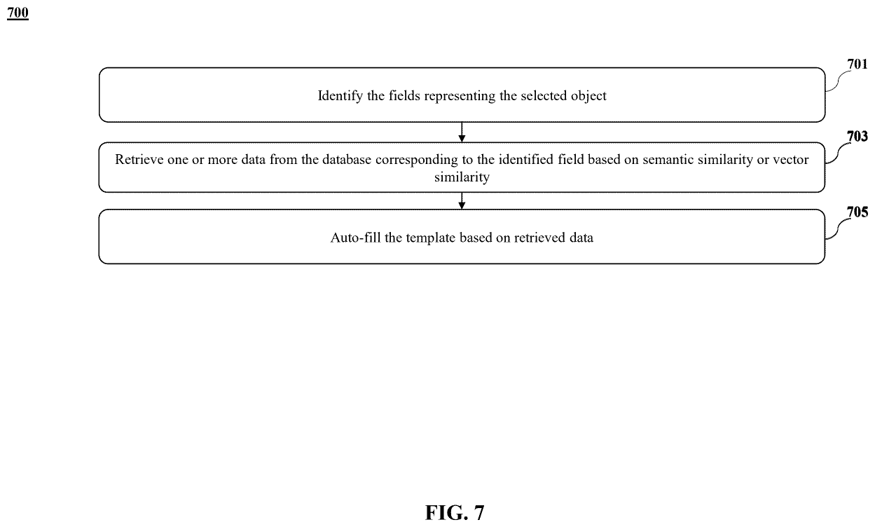

FIG. 7 illustrates a flow chart of a method for auto-filing the blank consignment recalling template, according to an embodiment of the present disclosure. According to an embodiment, a method 700 is performed by the recalling module 201. Method 700 will be explained by referring to FIGS. 2, 3, 5, and 6.

According to an embodiment, as the one or more fields are created based on the selected one or more objects as shown in block 511 of FIG. 5, the recalling module 201, fetches metadata associated with each field from the entity database 107 via the data management cloud service 109. As an example, the metadata is an unstructured field that describes the field being used in the consignment recalling template. For example, if the entity database 107 contains a field called the lot number, then the associated description which explains what a lot number is and what is its purpose in manufacturing/dispensing of the current batch is also fetched from the entity database 107. According to an embodiment, the fetched metadata is then stored into the database 213 for performing the semantic similarity or the vector similarity. The fetched metadata is stored along with its corresponding column identification (ID).

In an operation 701, the recalling module 201 identifies the fields representing the selected objects. According to an embodiment, the identification of the field is performed in order to auto-fill the relevant information associated with the fields from the entity database 107. As explained above, the information, related to the consumer product that was manufactured by the entities 101, is stored in the entity database 107. Further, the information is stored according to the specific format, the specific structure, or the data models as defined at the entities 101 ends. Therefore, identifying a context of the fields in order to auto-fill the consignment recalling template is paramount.

In an embodiment, the recalling module 201 is implemented with natural language processing (NLP) models in order to identify the fields. Accordingly, the recalling module 201 extracts the textual data within the field by using NLP models. Further, the recalling module 201 performs tokenization of the textual data within the field, the fetched metadata associated with each field, and a text included in the generated blank consignment recalling template 600.

The tokenization is the process of dividing a text into smaller units, typically words, sub-words, or symbols. These units, known as tokens, which is further used for NLP analysis. When the NLP model processes the textual data, the raw input text is tokenized into smaller units to facilitate subsequent analysis. By breaking down the text into tokens. The tokens may represent numerical vectors in a high-dimensional space. The NLP models can effectively interpret and understand the semantic similarity and meaning of the data.

In an embodiment, a tokenized output of the tokenized textual data within the field, the fetched metadata associated with each field, and the text included in the generated blank consignment recalling template 600 is then passed through a machine learning (ML) service platform (e.g. Sagemaker). In an embodiment, the machine learning (ML) service platform applies cosine similarity or feeds the tokenized output as an input to a large language model (LLM). According to an embodiment, based on the application of the cosine similarity or using LLMs, the semantic similarity or the vector similarity is determined. According to one or more embodiments, the semantic similarity is determined by comparing the geometric properties of the tokens to assess their likeness in meaning or context. According to a further embodiment, the vector similarity can be calculated using various mathematical operations such as the cosine similarity, Euclidean distance, or other similarity metrics. This process helps the NLP models understand and quantify the similarity between words, sentences, or entire text in the consignment recalling template documents.

According to an embodiment, the recalling module 201 provides a similarity score for each of the tokenized output. In an embodiment, the similarity score provides a degree of semantic similarity or vector similarity between the field and the fetched metadata.

According to an embodiment, at operation 703, the recalling module 201 retrieves one or more data from the entity database 107 corresponding to the identified field which has a high degree of semantic similarity or vector similarity between field and fetched metadata. Further, at operation 705, the recalling module 201 auto-fills the selected fields of the template based on the one or more data retrieved from the entity database 107.

Table 1 illustrates an example of retrieving the relevant data based on the similarity score.

TABLE 1

| | Fetched | Tokenized | Similarity | Final |
|---|---|---|---|---|
| Fields | Metadata | words | score | Retrieved data |
| Name | The consignee | Consignee, | Consignee - | Mr. xx |
| | name is Mr. xx | Mr. xx | 0.2 | |
| | | | Mr. xx - 0.5 | |
| Firm Address | Mr. xx works at | Company, | Company - 0.2 | 464, xx Road, |
| | X Pharmacy | located, plot no | plot no | Industrial Area, |
| | Pvt. Ltd. The | number 464, xx | number 464 - | Delhi (NCR), |
| | company is | Road, Industrial | 0.5 | India. |
| | located at house | Area, Delhi | Industrial | |
| | number 464, xx | (NCR), India. | Area - 0.7 | |
| | Road, | | Delhi | |
| | Industrial Area, | | (NCR), | |
| | Delhi (NCR), | | India - 0.8 | |
| | India. | | | |

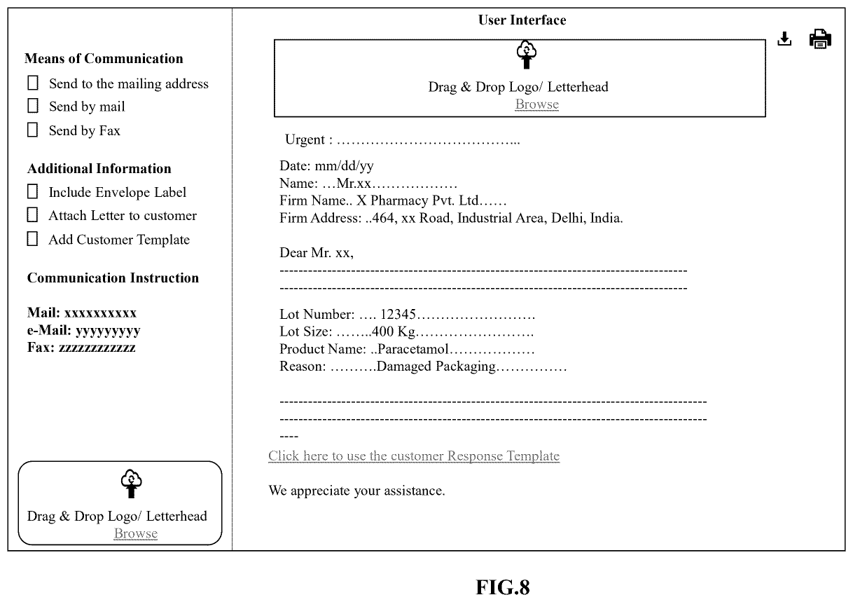

Referring back to the example depicted in FIG. 5, for the created fields 511 the retrieved data to be auto-filled is depicted at block 513. FIG. 8 illustrates an example of an auto-filled consignment recalling template, according to an embodiment of the present disclosure. As can be seen the consignment recalling template is auto-filled with the retrieved data as depicted at block 513 of FIG. 5.

According to some embodiment, the recalling module 201 provides editing functionality in case the auto-filled data is incorrect or the entity 101 wants to add any further additional details. Referring back to FIG. 6, the UI 111 provides a text editor 613 including an editor 615 respective of each field. In an embodiment, the entity 101 can edit the auto-filled data. The edited data can be stored in the database 213 for using the same in future operations.

According to some embodiment, the recalling module 201 may provide recommendation data based on the retrieved data from the entity database 107 instead of auto-fill it. Accordingly, the entity 101 may accept or reject the recommendation. In case the entity 101 accepts the recommendation then the recalling consignment template automatically fills the respective fields with the recommended data.

According to a further embodiment, the prompt generation module 209 is configured to generate the recalling prompt after the generation of the auto-filled consignment recalling template. Referring to FIG. 6, consider that the entity 101 selects ‘send by mail’ as the means of communication for sending the auto-filled consignment recalling template. The prompt generation module 209 fetches the list of mail addresses from the metadata.

Accordingly, the prompt generation module 209 generates the one or more recalling prompts for sending the auto-filled consignment recalling template to one or more end users. In an embodiment, the prompt generation module 209 generates the one or more recalling prompts based on a number of end users or the vendors 105 that are connected to the one or more entities 101 for recalling the products. Thus, the auto-filled consignment recalling template is sent to the number of end users or vendors 105 based on the selection of the means of communication. According to a further embodiment, the communication module 211 sends the one or more recalling prompts for distributing the auto-filled consignment recalling template to one or more end users or the vendors 105. Thus, the present disclosure provides an effective way of automating the product recall management system.

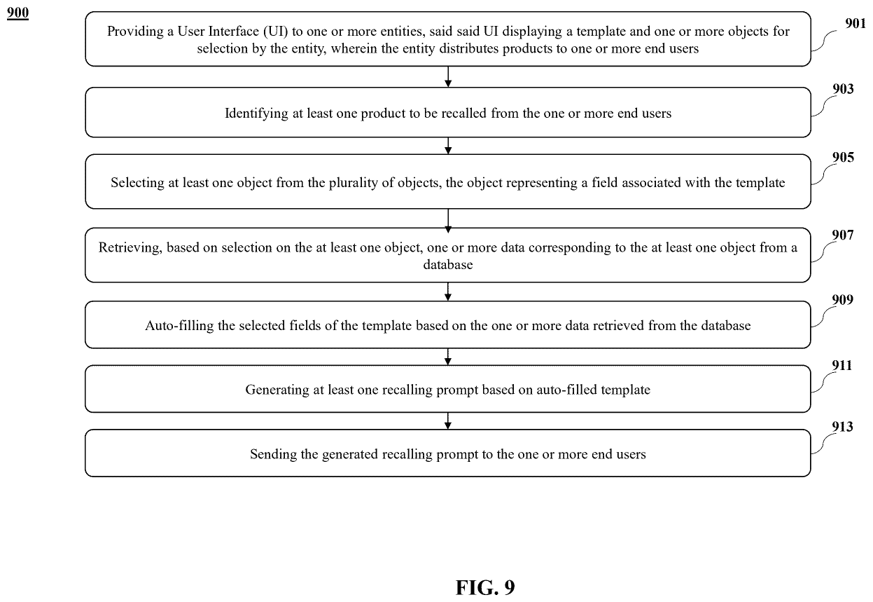

FIG. 9 illustrates a method for auto-filling a consignment recalling template, in accordance with an embodiment of the present disclosure. The method 900 is implemented in the system 103 of FIGS. 1, 2 and 3. According to an embodiment, the method 900 may be implemented with the processor(s) 203, various modules. An explanation of the various modules is explained through FIGS. 1-8, therefore detailed explanation of the same is omitted here for the sake of brevity.

According to an embodiment, at operation 901, the method 900 includes providing the UI 111 to one or more entities 101. The method 900 includes displaying a template and a plurality of objects for selection by the entity on the UI 111. In an example, the entity 101 distributes products to one or more end users. In an embodiment, the template can be alternately referred to as the consignment recalling template throughout the disclosure. Further, the method 900 includes providing one or more predetermined templates for the selection by the entity 101.

Referring to FIG. 4, the UI 111 provides a “select template” 405 tab so that after operating upon the select template 405 tab, the UI 111 displays various predefined consignment templates 403 for selecting any one of the consignment templates. According to an embodiment, the UI 111 provides the ‘select’ 407 tab and the ‘display’ 409 tab for performing selection and displaying operations. Thus, as the UI 111 displays various predefined consignment templates 403, the entity 101 can select any one of the consignment templates by operating upon the select 407 tab and thereafter can operate upon the display 409 for displaying the selected consignment template. Thus, when the entity 101 selects a particular consignment template, the UI 111 displays the selected consignment template which is depicted in block 411.

Thereafter, at operation 903, the method 900 includes identifying at least one product to be recalled from the one or more end users. In an embodiment, the object module 207 performs identification of the at least one product to be recalled based on the selected consignment template. In an embodiment, the object module 207 uses Artificial intelligence (AI) models to understand the context of the selected consignment template. A detailed explanation is provided with reference to the object module 207, therefore for the sake of brevity the same is omitted here.

Further, the at operation 905, the method 900 includes selecting at least one object from the plurality of objects, the object representing the field associated with the template. In an embodiment, in selecting the at least one object from the plurality of objects, the method 900 includes providing drag and drop function for the selected object at the predetermined location of the UI 111.

Referring to FIG. 5, the UI 111 provides the ‘select field’ 501 tab for selecting one or more objects that are to be included as the field in the selected consignment recalling template. In an embodiment, based on the identified product, and after operating upon the select field 501, the object module 207 provides a list of objects 503. The list of objects 503 is displayed on the UI 111. In an embodiment, the entity 101 can select one or more objects from the list of objects 503. The UI 111 provides a ‘select’ 505 tab for selecting the one or more objects. According to a further embodiment, the UI 111 provides the entity 101 to perform the drag and drop operation by operating upon the drag/drop 505 tab. The selected objects are displayed on the UI 111 as fields as shown in the block 511. According to an embodiment, the selected objects are placed at the predetermined location of the selected recalling consignment template.

Further, at operation 907, the method 900 includes retrieving, based on the selection on the at least one object, one or more data corresponding to the at least one object from the entity database 107. In an embodiment, the operation 907 includes operations 701 and 703 of FIG. 7. According to an embodiment, the method 900 at first includes identifying the fields representing the selected object (as explained in the operation 701). Thereafter, the method 900 includes retrieving one or more data from the entity database 107 corresponding to the identified field which has the high degree of semantic similarity or the vector similarity between the field and the fetched metadata (as explained in the operation 703).

Further, at operation 909, the method 900 includes auto-filling the selected fields of the template based on the one or more data retrieved from the entity database 107. The operation 909 corresponds to the operation 705 of FIG. 7. The operation 907 and 909 is explained in detail through operation steps 701 to 705. Therefore, a detailed explanation of the same is omitted here for the sake of brevity.

Further, at operation 911, the method 900 includes generating at least one recalling prompt based on the auto-filled template. In an embodiment, the method 900 includes generating a plurality of recalling prompts based on a number of end users who are connected to the one or more entities 101 for recalling the products. In a non-limiting example, the one or more recalling prompts can be an e-mail, a fax, a short message service (SMS), a notification, a broadcast message, and the like. Referring to FIG. 6 the prompt may be generated by selecting any one of options provided under the means of communication 601. Further, at operation 913, the method 900 includes sending the generated recalling prompt along with the auto-filled consignment recalling template to the one or more end users or vendors 105.

According to a further embodiment, method 900 includes enabling customization of the UI 111 by the one or more entities 101 based on specific end users or specific recalled products.

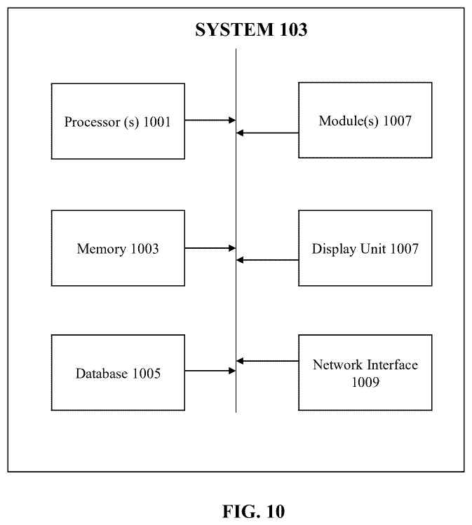

FIG. 10 illustrates a general block diagram of the system, according to an embodiment of the present disclosure.

In an example, the processor(s) 1001 may be a single processing unit or a number of units, all of which could include multiple computing units. The processor(s) 1001 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 1001 is configured to fetch and execute computer-readable instructions and data stored in the memory 1003.

The memory 1003 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an example, the module(s), engine(s), and/or unit(s) 1007 may include a program, a subroutine, a portion of a program, a software component or a hardware component capable of performing a stated task or function. As used herein, the module(s), engine(s), and/or unit(s) may be implemented on a hardware component such as a server independently of other modules, or a module can exist with other modules on the same server, or within the same program. The module(s), engine(s), and/or unit(s) 1003 may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit(s) 1003 when executed by the processor(s) 1001 may be configured to perform any of the described functionalities. According to an embodiment, the module 1003 includes a recalling module 201, the object module 207, the prompt generation module 209, and the communication module 211. In an alternate embodiment, the functions of the aforesaid modules may be performed by the processor(s) 1001.

As a further example, the database 1005 may be implemented with integrated hardware and software. The hardware may include a hardware disk controller with programmable search capabilities or a software system running on general-purpose hardware. Examples of databases are but not limited to, in-memory databases, cloud databases, distributed databases, embedded databases, and the like. The database amongst other things, serves as a repository for storing data processed, received, and generated by one or more of the processor(s) 1001, and the modules/engines/units 1005.

The modules/engines/units 1005 may be implemented with an AI module that may include a plurality of neural network layers. Examples of neural networks include, but are not limited to, a convolutional neural network (CNN), a deep neural network (DNN), a recurrent neural network (RNN), a Restricted Boltzmann Machine (RBM). The learning technique is a method for training a predetermined target device using a plurality of learning data to cause, allow, or control the target device to make a determination or prediction. Examples of the learning techniques include, but are not limited to, a supervised learning, an unsupervised learning, a semi-supervised learning, or a reinforcement learning. At least one of a plurality of CNN, DNN, RNN, RMB models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

As an example, the display unit 1007 includes a computer monitor, a touch screen, an output device capable of displaying the graphics, and the like. The display unit 1007 is configured to display visual output in desktops, laptops, and workstations.

As a further example, the network interface 1009 is configured to provide and establish communication with any electronic device via a public network, private network, or any wireless communication technology.

The disclosed system and method may thereby be used for automating the product recall management process. The issues that can arise due to the dispatch of faulty products are crucial. More, particularly for the pharmaceutical and medical industries, maintaining consumer safety and regulatory compliance is paramount. Thus, when the organization needs to recall its faulty products due to various reasons as explained in the background section, the conventional method of manually sending notifications or emails is inefficient, time-consuming, and prone to errors as the end users are generally very large in numbers. The disclosed techniques provide an effective method for automating the filing of the consignment recalling templates. The system automatically populates the relevant data to be filled in respective fields of the consignment recalling template by retrieving appropriate data from the entity's database. The implementation of the semantic similarity or vector similarity techniques aids in retrieving appropriate data from the entity's database in spite of the manner the information is maintained therein. Accordingly, the disclosed techniques significantly improve the accuracy of information retrieval, thereby providing accurate recommendations and auto-filling of the consignment recalling templates.

The disclosed system and method leverage technology to streamline the consignment recall process. By this, the organization can maintain effective supply chain management. The disclosed approach helps in maintaining trust within the industry and among consumers, while also ensuring compliance with regulatory requirements.

The figures of the disclosure are provided to illustrate some examples of the invention described. The figures are not to limit the scope of the depicted embodiments of the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a scripting language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

We claim:

1. A system for auto-filling a consignment recalling template, comprising:
a processor;
a memory storing program instructions which, when executed by the processor, causes the processor to:
provide a User Interface (UI) to one or more entities, said UI displaying a template and a plurality of objects for selection by the entity, wherein the entity distributes products to one or more end users;
identify at least one product to be recalled from the one or more end users;
select at least one object from the plurality of objects, the object representing a field associated with the template;
retrieve, based on the selection on the at least one object, one or more data corresponding to the at least one object from a database;
auto-fill the selected fields of the template based on the one or more data retrieved from the database;
generate at least one recalling prompt based on auto-filled template; and
send the generated recalling prompt to the one or more end users.

2. The system of claim 1, wherein in selecting the at least one object from the plurality of object, the processor is configured to:
provide drag and drop function for the selected object at a predetermined location of the User Interface.

3. The system of claim 1, wherein the processor is further configured to:
provide one or more predetermined templates for selection by the entity.

4. The system of claim 1, wherein in the auto-filling of the template based on selection of the object, the processor is further configured to:
identify the fields representing the selected object;
retrieve one or more data from the database corresponding to the identified field; and
auto-fill the template based on retrieved data.

5. The system of claim 4, wherein the processor is further configured to:
retrieve one or more data from the database based on semantic similarity or vector similarity.

6. The system of claim 1, wherein the processor is further configured to:
generate a plurality of recalling prompts based on the number of end users who are connected to the one or more entities recalling the products.

7. The system of claim 1, wherein the processor is further configured to:
enable customization of the User Interface by the one or more entities based on specific end users or specific recalled products.

8. A method for auto-filling a consignment recalling template, comprising:
providing a User Interface (UI) to one or more entities, said UI displaying a template and a plurality of objects for selection by the entity, wherein the entity distributes products to one or more end users;
identifying at least one product to be recalled from the one or more end users;
selecting at least one object from the plurality of objects, the object representing a field associated with the template;
retrieving, based on the selection on the at least one object, one or more data corresponding to the at least one object from a database;
auto-filling the selected fields of the template based on the one or more data retrieved from the database;
generating at least one recalling prompt based on auto-filled template; and
sending the generated recalling prompt to the one or more end users.

9. The method of claim 8, comprising:
providing drag and drop functionality for the selected object at a predetermined location of the User Interface.

10. The method of claim 8, further comprising:
providing one or more predetermined template for selection by the entity.

11. The method of claim 8, wherein in the auto-filling of the template based on selection of the object, the method comprises:
identifying the fields representing the selected object;
retrieving one or more data from the database corresponding to the identified field; and
auto-filling the template based on retrieved data.

12. The method of claim 11, further comprising:
retrieving one or more data from the database based on semantic similarity or vector similarity.

13. The method of claim 8, further comprising:
generating a plurality of recalling prompts based on the number of end users who are connected to the one or more entities recalling the products.

14. The method of claim 8, further comprising:
enabling customization of the User Interface by the one or more entities based on specific end users or specific recalled products

15. A non-transitory computer-readable storage medium storing program instructions for auto-filling a consignment recalling template, the instructions, when executed, perform the steps of:
providing a User Interface (UI) to one or more entities, said UI displaying a template and a plurality of objects for selection by the entity, wherein the entity distributes products to one or more end users;
identifying at least one product to be recalled from the one or more end users;
selecting at least one object from the plurality of objects, the object representing a field associated with the template;
retrieving, based on the selection on the at least one object, one or more data corresponding to the at least one object from a database;
auto-filling the selected fields of the template based on the one or more data retrieved from the database;
generating at least one recalling prompt based on auto-filled template; and
sending the generated recalling prompt to the one or more end users.

16. The non-transitory computer-readable storage medium as claimed in claim 15, further comprising program instructions to perform the steps of:
providing drag and drop functionality for the selected object at a predetermined location of the User Interface.

17. The non-transitory computer-readable storage medium as claimed in claim 15, further comprising program instructions to perform the steps of:
providing one or more predetermined template for selection by the entity.

18. The non-transitory computer-readable storage medium as claimed in claim 15, wherein in the auto-filling of the template based on selection of the object, comprising program instructions to perform the steps of:
identifying the fields representing the selected object;
retrieving one or more data from the database corresponding to the identified field; and
auto-filling the template based on retrieved data.

19. The non-transitory computer-readable storage medium as claimed in claim 18, further comprising program instructions to perform the steps of:
retrieving one or more data from the database based on semantic similarity or vector similarity.

20. The non-transitory computer-readable storage medium as claimed in claim 15, further comprising program instructions to perform the steps of:
generating a plurality of recalling prompts based on the number of the end users who are connected to the one or more entities recalling the products.
